(19) United States
(12) Patent Application Publication
(10) Pub. No.: US 2013/0035991 A1
(43) Pub. Date: Feb. 7, 2013

(54) SYSTEM AND METHOD FOR DISTRIBUTING VIRTUAL INCENTIVES FOR REAL WORLD ACTIVITIES BETWEEN MULTIPLE USERS

(71) Applicants: Christopher Romero, New York, NY (US); Ria Concepcion, Sunnyside, NY (US)

(72) Inventors: Christopher Romero, New York, NY (US); Ria Concepcion, Sunnyside, NY (US)

(73) Assignee: FunGoPlay LLC, Maplewood, NJ (US)

(21) Appl. No.: 13/197,641

(22) Filed: Aug. 3, 2011

(51) Int. Cl. G06Q 30/02

(52) U.S. Cl. 705/14.1

(57) ABSTRACT

Real-world physical activity—of a user of a virtual space—may be rewarded with a virtual incentive including one or more virtual benefits in a virtual space. The virtual incentive may be associated with a particular user in the virtual space. The particular user may enter and/or select other users to obtain a virtual benefit, e.g. for their participation in the real-world physical activity that formed the basis for the reward. After the one or more virtual incentives are determined for one or more users, the virtual incentives are distributed to the one or more users.

### RELATED APPLICATIONS

This application is related to U.S. patent application Ser. No. 13/184,402, entitled “Systems and Methods for Providing Virtual Incentives For Real-World Activities,” and filed Jul. 15, 2011. All of the related applications are hereby incorporated by reference into the present application in their entirety.

### FIELD OF THE DISCLOSURE

This disclosure relates to systems and methods for distributing virtual incentives for real-world physical activities between multiple users. A virtual incentive may be awarded to a first user for performance of real-world physical activities, such as playing sports. The first user may enter and/or select a second user to receive a second virtual incentive. The virtual incentives may be distributed to the users. The virtual incentives may comprise one or more virtual benefits in a virtual space.

### BACKGROUND

The power of incentives is known to work not only in the real world, but also in online virtual worlds, video games and other computer-generated environments. Users of such virtual environments, whether they are referred to as residents, gamers, or by other terms, are subjected to and/or tempted by a wide variety of incentives. For example, users may earn rewards for spending a certain amount of time while engaged with a virtual environment, for reaching certain goals and/or generally making progress, for reaching certain goals within a certain amount of time, for defeating enemies, for helping friends and/or teammates, for spending a certain amount of real and/or virtual currency, for out-performing other users, and/or for other reasons to earn rewards. Rewards may include one or more of a monetary component, virtual goods and/or services, virtual skills and/or abilities, status, recognition, privileges, bragging rights, and/or any other object and/or reward, virtual or not, that a user of such an environment might consider worthwhile. Incentives may be targeted to specific environments, since, e.g., users of World of Warcraft® may respond to different incentives than users of Club Penguin®. Incentives and/or rewards need not be confined to the same virtual environment. For example, a user of one particular game and/or application on the iPhone® platform may earn virtual rewards for buying, downloading, installing, and/or trying out a different application on the iPhone® platform, usually on the same computing device. Incentives and/or rewards are commonly awarded on a per-user basis, rather than being distributed among multiple users.

### SUMMARY

One aspect of the disclosure relates to a system and/or method for distributing virtual incentives for real-world activities between multiple users. Real-world activities may include physical play (e.g. using sports equipment and/or other play), and/or other activities. The virtual incentives may be distributed to a plurality of users for cooperative real world activities based on user selections made by one of the users to which the physical activity has been previously associated. Such a system may be configured to execute one or more of an activity notification module, an interface module, an incentive module, a distribution module, and/or other modules.

The activity notification module of the system may be configured to receive a notification of performance of real-world physical activity (allegedly and/or presumably) by a user of a virtual space. This user may be referred to as the primary user. The notification may be a basis for one or more virtual incentives and/or rewards in a virtual space. The one or more virtual incentives for the primary user may be referred to as the primary virtual incentive. The notification may comprise one or more of a code obtained from the user, an electronic message sent on behalf of the user, an electronic message obtained via logic embedded in sports equipment and/or gear, and/or other notifications. In some implementations, play objects may be used that are able to detect real-world activity and/or play, and measure whether a threshold amount level of such activity and/or play has been performed with the play object. In response, the play object may present a so-called level code to a user, which may be a notification for the activity notification module.

There may be many types of virtual incentives. For example, a virtual incentive may comprise one or more of an amount of virtual currency for the virtual space, a virtual good and/or service in the virtual space, unlocking of a virtual place and/or virtual activity within the virtual space, leveling up within the virtual space, experience points, a buff and/or power boost available for future use during one or more of a task, an assignment, a game, an activity, a mission, a quest, a challenge, a competition, and/or a tournament in the virtual space, a virtual skill and/or ability, a virtual pet, a relationship (or improved relationship) with a non-player character within the virtual space, and/or other content unlocks and/or virtual incentives. Virtual incentives of different types may be combined as a reward.

The interface module of the system may be configured to generate an interface for presentation to the user. The interface may be configured to receive entry and/or selection of one or more secondary users that (allegedly and/or presumably) participated in at least some of the performed real-world physical activity. A secondary user may not (yet) have a user account in the virtual space. The interface may be further configured to receive entry and/or selection of one or more distribution parameters that impact the distribution of one or more incentives to the primary and/or the secondary user(s). For example, this parameter may include one or more of a portion of the performed real-world physical activity performed by the secondary user(s), a time period of the real-world physical activity corresponding to the (alleged, presumed, and/or estimated) participation of the secondary user(s), a size of a portion of the virtual incentive that should be distributed to the secondary user(s), a selection of one or more options for one or more virtual incentives that should be distributed to the secondary user(s), and/or other parameters.

The incentive module of the system may be configured to determine the primary virtual incentive for the primary user and one or more secondary virtual incentives for the secondary user(s). The virtual incentives may be rewards for the performance of real-world physical activity. The virtual incentives may comprise one or more virtual benefits in virtual space. Operation of the incentive module may be responsive to obtaining the notification by the activity notification module and/or obtaining the entry and/or selection of the secondary user(s) through the interface module. One or more virtual incentives may be determined based on one or more distribution parameters obtained, e.g., through the interface module. The primary virtual incentive may be a different type of virtual incentive than the one or more secondary virtual incentives. Multiple secondary virtual incentives may be a different type of virtual incentives. Distribution parameters may apply to individual virtual incentives. Distribution parameters may be entered and/or selected per individual virtual incentive. The entry and/or selection of the secondary virtual incentives (and/or the selection of options for one or more secondary virtual incentives) may diminish and/or increase the primary incentive as a result. In some implementations the primary incentive may be unaffected by a secondary virtual incentive.

The distribution module of the system may be configured to distribute the primary virtual incentive to the primary user. The distribution module may be configured to distribute one or more secondary virtual incentives to one or more secondary users. Distribution may comprise, for users of the virtual space having user accounts, adding a virtual incentive to the appropriate user account, e.g. by adding a virtual incentive to the virtual inventory associated with a user account. Distribution may comprise sending a user an electronic message containing a redeemable token. If one or more secondary users are not (yet) associated with the virtual space and/or do not yet have a user account, distribution may comprise sending the one or more secondary users an invitation to register as a user of the virtual space and/or open a user account.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for distributing virtual incentives for real-world activities between multiple users.

FIG. 2 illustrates an exemplary embodiment of a user interface in accordance with one or more implementations.

FIG. 3 illustrates an exemplary method for distributing virtual incentives for real-world activities between multiple users.

### DETAILED DESCRIPTION

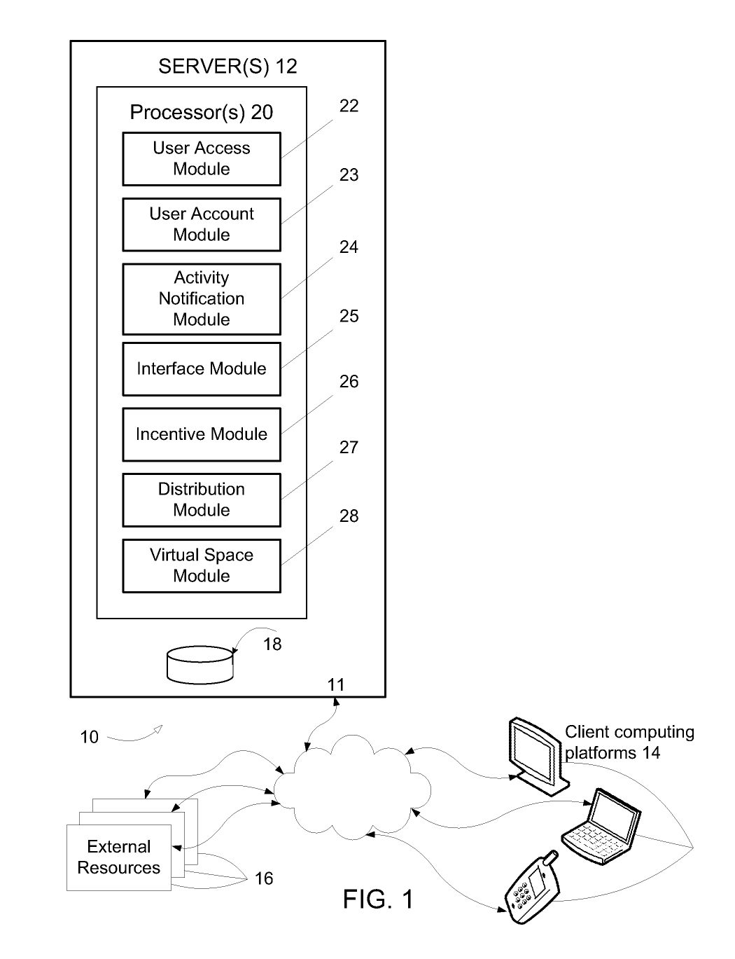

FIG. 1 illustrates a system 10 for distributing virtual incentives for real-world activities between multiple users. The virtual incentives may comprise one or more virtual benefits in a virtual space. System 10 may provide and/or host the virtual space over a computer network. System 10 may include one or more server(s) 12, one or more client computing platform(s) 14, external resources 16, one or more electronic communication connection(s) 11, and/or other components. Server 12 may be configured to communicate with one or more client computing platforms 14 according to, e.g., a client/server architecture and/or another communication architecture. The users may access system 10 and/or the virtual space via client computing platforms 14.

Server(s) 12 may include one or more processor(s) 20, electronic storage 18, a network connection 11 (such as communication lines, or ports), and/or other components. Network connection 11 may enable the exchange of information with one or more networks (e.g. the Internet) and/or other computing platforms.

It will be appreciated that discussion herein of “the connection” between server 12 and, e.g., client computing platform 14 is not limited to a single communication pathway, protocol, or set of protocols. For example, “the connection” may refer to an RF communication connection (e.g., CDMA, 3G, and/or other RF communication connections) and/or a WiFi connection that may be used alternatively to each other by the same client computing platform 14 and server 12 to communicate.

The one or more processors 20 may be configured to execute a user access module 22, a user account module 23, an activity notification module 24, an interface module 25, an incentive module 26, a distribution module 27, a virtual space module 28, and/or other modules. Processor(s) 20 may be configured to execute modules 22, 23, 24, 25, 26, 27, and/or 28 by software; hardware; firmware; some combination of software, hardware, and/or firmware; and/or other mechanisms for configuring processing capabilities on processor(s) 20.

User account module 23 of system 10 may be configured to manage user accounts in a virtual space that include account information of users. Individual user accounts may be associated with individual users. User account module 23 may be configured to support registration of new users of system 10. For example, registration may be supported by presenting registration functionality to new users of system 10. Such functionality may be presented through, e.g., a dedicated web page on the Internet, a stand-alone executable computer program, and/or via other mechanisms for interfacing with users.

Registration of a new user may include presentation of a registration interface to a new user. Registration of a new user may comprise activation of a new user account in the virtual space such that the new user account is associated with the new user.

Registration of a new user may include the assignment or selection of a username and/or other information identifying a user (e.g. a name, an alias, a handle, a number, an identifier, and/or other identifying information). For example, a new user may select a username by entering the username via the registration interface. Registration of a new user may include the assignment or selection of account access authorization used to control and/or authorize access to a user account, to gain access to certain functions of system 10, to log in to the virtual space, and/or to perform other activities that require authorization. Account access authorization may include one or more of an access code, password, biometric information, a security token, proximity information, an RF token, and/or other ways to supply information that may be used to authorize access to system 10 in an attempt to uphold security. For example, a new user may select a password by entering the password via the registration interface.

During registration of a user, other account information may be entered by the user as well, including a selection of an avatar to represent the user in the virtual space, customizations for the avatar, user settings and/or preferences, personal user information (e.g. age range and/or year of birth of the user), subscription information, virtual currency account information, and/or other account information. The account information may include an amount of virtual currency, which may be held in credit for the user associated with the user account for use within the virtual space.

User access module 22 of system 10 may be configured to manage user access to system 10, and/or access to account information and/or a user profile of a user. User access may comprise receipt of an account access authorization. Access to system 10 may be granted pursuant to setup and/or registration of a user account. Access to system 10 may require one or more of a user account, a user name and/or user identifier, account access authorization (e.g. an access code and/or password), and/or other information. Other functionalities attributed herein to modules of system 10 may be unavailable to a user until access has been authorized through user access module 22. User access module 22 may be configured to generate an authorization user interface for presentation to the user through which entry and/or selection of the required information, including the account access authentication, may be obtained. This authorization user interface may be presented to a user, for example, through client computing platform 14.

Activity notification module 24 of system 10 may be configured to obtain a notification of performance of real-world physical activity by a user of a virtual space. The user associated with a notification may be referred to as a “primary user” for the notification. The notification may be a basis for providing one or more virtual incentives and/or rewards in a virtual space. The one or more virtual incentives for the primary user may be referred to as the primary virtual incentive.

The one or more virtual incentives associated with a notification may include, for example, one or more of an amount of virtual currency for the virtual space, a virtual good and/or service in the virtual space, unlocking of a virtual place and/or virtual activity within the virtual space, leveling up within the virtual space, experience points, a buff and/or power boost available for future use during one or more of a task, an assignment, a game, an activity, a mission, a quest, a challenge, a competition, and/or a tournament in the virtual space, a virtual skill and/or ability, a virtual pet, a relationship (or improved relationship) with a non-player character within the virtual space, and/or other virtual incentives.

A virtual good may be classified as one or more of decorative, functional, access-driven, behavioral, and/or other classifications. A virtual good may include, without limitation, an object with or without abilities, an ingredient, a virtual mineral or ore, a virtual herb, leaf, stem, seeds or root, a protective object, a tool, a weapon, a pet, a vehicle, a mount, a map, clothing, furniture, buildings, floors, wallpaper, powerups, currency, documents, music, newspapers, magazines, other media, artwork and/or other goods or items.

The notification obtained by activity notification module 24 may comprise one or more of a code obtained from the user, an electronic message sent on behalf of the user, an electronic message obtained via logic embedded in sports equipment and/or gear, sensor output monitoring user activity, verification of user activity by a third party (e.g., a third party certified or qualified to verify activity to system 10, and/or other third parties) and/or other notifications. In some implementations, the notification includes one or more incentive criteria, which may be relied upon when determining the virtual incentive for one or more users. For example, the incentive criteria may be a measure of the amount of real-world physical activity that is performed and/or a measure of the size and/or amount of the corresponding virtual incentive. In some implementations incentive criteria may be obtained from another component of system 10. For example, the incentive criteria for a given performance may be predetermined and stored in electronic storage 18. In some implementations, play objects may be used that are able to detect real-world activity and/or play, and measure whether a threshold amount level of such activity and/or play has been performed with the play object. In response, the play object may present a level code to a user. The user may input the level code to, e.g., interface module 25. The level code may serve as a notification for activity notification module 24.

Interface module 25 of system 10 may be configured to generate an interface for presentation to the user. The interface may be configured to receive entry and/or selection of one or more secondary users that participated in at least some of the performed real-world physical activity. A secondary user may not have previously registered a user account in the virtual space. The interface may be further configured to receive entry and/or selection of one or more distribution parameters that impact the distribution of one or more incentives to the primary and/or the secondary user(s). For example, this parameter may include one or more of a portion of the performed real-world physical activity performed by the secondary user(s), a time period of the real-world physical activity corresponding to the (alleged, presumed, measured, estimated, or quantified in other ways) participation of the secondary user(s), a size of a portion of the virtual incentive that should be distributed to the secondary user(s), a selection of one or more options for one or more virtual incentives that should be distributed to the secondary user(s), and/or other parameters.

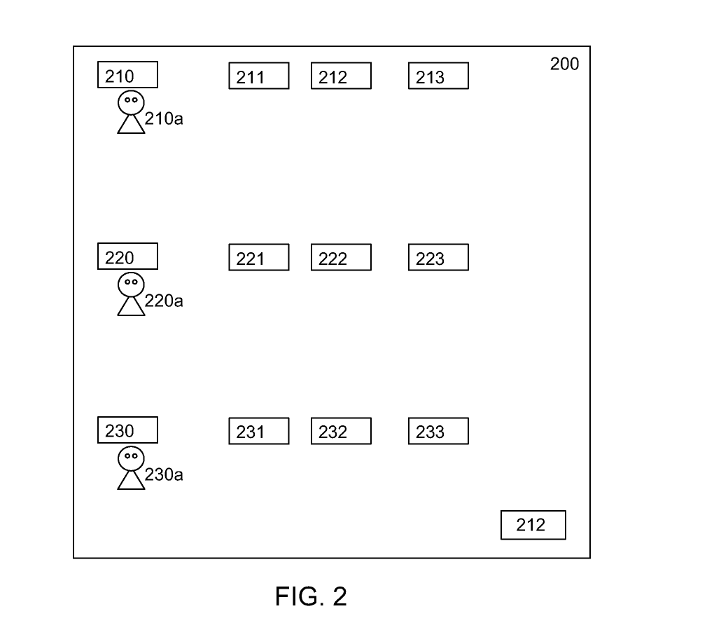

By way of illustration, FIG. 2 illustrates an exemplary embodiment of a user interface 200 for distributing, between multiple users, virtual incentives for real-world physical activities, in accordance with one or more implementations. User interface 200 may be presented to, e.g., the primary user through, e.g., a particular client computing platform 14. User interface 200 may be used in system 10 to reward a virtual incentive to the primary user for the performance of real-world physical activity. User interface 200 may be configured to obtain, from the primary user, entry and/or selection of one or more secondary users that participated in the real-world physical activity for which the primary user is being rewarded, so that one or more virtual incentives may be distributed to the one or more secondary users. User interface 200 may include interaction elements 210-213, 220-223, 230-233, and/or other interaction elements. Interaction elements may be implemented as fields configured to receive entry and/or selection from the primary user. The fields may include one or more of a text entry field, a set of selectable menu items, a selectable field, and/or other fields configured to receive entry and/or selection from the primary user.

User interface 200 may include interaction element 210, which may present an identifier associated with the primary user of system 10. User interface 200 may include avatar 210a, which may represent an avatar associated with the primary user. User interface 200 may include interaction element 220 and/or avatar 220a. Interaction element 220 may present an identifier associated with a secondary user of system 10. Avatar 220a may represent an avatar associated with the secondary user identified through interaction element 220. Interaction element 220 may be used, e.g. by the primary user, to enter and/or select a secondary user that participated in at least some of a performed real-world physical activity for which virtual incentives are to be awarded. The primary user may enter and/or select secondary users from various sources, including a friend list, a set of virtual space users, an email address for a secondary user, and/or other sources for identifying secondary users. For example, the primary user may select a friend from a list of friends through interaction element 220. Responsive to this selection, avatar 220a may be updated to match the selected secondary user associated with interaction element 220. Interaction element 230 may be used, e.g. by the primary user, to enter and/or select another secondary user, presumably different from the secondary user associated with interaction element 220, that participated in at least some of a performed real-world physical activity for which virtual incentives are to be awarded. Responsive to the selection of another secondary user associated with interaction element 230, avatar 230a may be updated to match the selected secondary user associated with interaction element 230.

Interaction elements 213 may represent a distribution parameter related to the distribution of virtual incentives. For example, interaction element 213 may represent a percentage of the performance of real-world physical activity to be awarded, and/or another distribution parameter. Interaction elements 223 and/or 233 may represent distribution parameters related to the distribution of virtual incentives. For example, interaction element 223 may represent a percentage of the performance of real-world physical activity to be awarded, and/or interaction element 223 may represent another distribution parameter, such that interaction element 223 may be associated with the secondary user identified through interaction element 220. Interaction element 233 may represent a percentage of the performance of real-world physical activity to be awarded, and/or interaction element 233 may represent another distribution parameter, such that interaction element 233 may be associated with the secondary user identified through interaction element 230. The percentages indicated by interaction elements 213, 223, and 233 may represent, e.g., a combined total of 100% of the performance of real-world physical activity that is to be rewarded.

Interaction element 211 may represent a virtual incentive that is (to be) awarded to the primary user for participation in the performance of real-world physical activity, which may be further specified through interaction element 213. Interaction element 212 may represent another virtual incentive that is (to be) awarded to the primary user. The virtual incentive represented by interaction element 212 may differ from the virtual incentive represented by interaction element 211. For example, interaction element 211 may represent an amount of virtual currency. Interaction element 212 may represent experience points. Interaction elements 221 and/or 222 may represent (different types of) virtual incentives that may be awarded to the secondary user identified through interaction element 220. Interaction elements 231 and/or 232 may represent (different types of) virtual incentives that may be awarded to the secondary user identified through interaction element 230. Interaction element 212 may present a functional element that, e.g., confirms the distribution of virtual incentives as entered and/or selected using the other interaction elements of user interface 200.

Incentive module 26 of system 10 may be configured to determine the primary virtual incentive for the primary user and one or more secondary virtual incentives for the secondary user(s). The determination may be based on and/or take into account the incentive criteria related to the performance of real-world physical activity to be rewarded. The virtual incentives may comprise one or more virtual benefits in virtual space. Operation of incentive module 26 may be responsive to obtaining the notification by activity notification module 24 and/or obtaining the entry and/or selection of the secondary user(s) through interface module 25.

Incentive module 26 may be configured to determine the primary and/or secondary virtual incentives based on one or more distribution parameters obtained, e.g., through interface module 25. For a given activity performed by the primary user, the primary virtual incentive may be a different type of virtual incentive than the one or more secondary virtual incentives. Multiple secondary virtual incentives may be a different type of virtual incentives. Distribution parameters may apply to individual virtual incentives. Distribution parameters may be entered and/or selected per individual virtual incentive. The entry and/or selection of the secondary virtual incentives (and/or the selection of options for one or more secondary virtual incentives) may diminish and/or increase the primary incentive as a result. In some implementations the primary incentive may be unaffected by a secondary virtual incentive.

Distribution module 27 of system 10 may be configured to distribute the primary virtual incentive to the primary user. Distribution module 27 may be configured to distribute one or more secondary virtual incentives to one or more secondary users. Distribution may comprise, for users of the virtual space having user accounts, adding a virtual incentive to the appropriate user account, e.g. by adding a virtual incentive to the virtual inventory associated with a user account. Distribution may comprise sending a user an electronic message containing a redeemable token. If one or more secondary users are not (yet) associated with the virtual space and/or do not yet have a user account, distribution may comprise sending the one or more secondary users an invitation to register as a user of the virtual space and/or open a user account.

Virtual space module 28 of system 10 may be configured to cause presentation of views from an instance of the virtual space to the user. The instance may be associated with the user account of the user. Virtual space module 28 may be configured to implement instances of the virtual space, which may be executed to determine views of the virtual space. The views may then be communicated (e.g., via streaming, via object/position data, and/or other information) from virtual space module 28 to client computing platforms 14 for presentation to users. The view determined and transmitted to a given client computing platform 14 may correspond to a user character being controlled by a user via the given client computing platform 14. The view determined and transmitted to a given client computing platform 14 may correspond to a location in a particular virtual environment (e.g., the location from which the view may be taken, the location the view depicts, and/or other locations), a zoom ratio, a dimensionality of objects, a point-of-view, and/or view parameters. One or more of the view parameters may be selectable by the user.

In some implementations, some or all of the functions attributed herein to virtual space module 28 may be provided and/or hosted by a third-party, external provider, operating outside of system 10 and/or server 12. It is contemplated that, e.g., distribution of a virtual incentive and/or benefit may be communicated with such an external provider, within the scope of this disclosure.

An instance of the virtual space may comprise a simulated space that may be accessible by users via clients (e.g., client computing platforms 14) that present the views of the virtual space to a user. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the simulated space. In some instances, the topography may describe a surface (e.g., a ground surface) that runs through at least a substantial portion of the simulated space. In some instances, the topography may describe a volume with one or more bodies positioned therein (e.g., a simulation of gravity-deprived space with one or more celestial bodies positioned therein). An instance of the virtual space may be synchronous, asynchronous, and/or semi-synchronous.

The above description of the manner in which views of the virtual space are determined is not intended to be limiting. Virtual space module 28 may be configured to express the virtual space (and/or any virtual objects therein) in a more limited, or more rich, manner. For example, views determined for a virtual space may be selected from a limited set of graphics depicting an event in a given place within the virtual space. The views may include additional content (e.g., text, audio, pre-stored video content, and/or other content) that describes particulars of the current state of the place, beyond the relatively generic graphics. For example, a view may include a generic battle graphic representation with a textual description of the opponents to be confronted. Other expressions of individual places, actions, and/or virtual objects within the virtual space are contemplated.

Within instance(s) of the virtual space, users may control characters, (virtual) objects, simulated physical phenomena (e.g., wind, rain, earthquakes, and/or other phenomena), and/or other elements to interact with the virtual space and/or each other. The user characters may include avatars. As used herein, the term “user character” may refer to an object (or group of objects) present in a virtual space that represents an individual user. The user character may be controlled by the user with which it may be associated. The user-controlled element(s) may move through and interact with the virtual space (e.g., non-user characters in the virtual space, objects in the virtual space). The user-controlled elements controlled by and/or associated with a given user may be created and/or customized by a user. The user may have an inventory of virtual goods and/or currency that the user can use (e.g., by manipulation of a user character or other user controlled element, and/or other items) within the virtual space.

Users may participate in instances of the virtual space by controlling one or more of the available user-controlled elements. Control may be exercised through control inputs and/or commands input by the users through one or more client computing platforms. The users may interact with each other through communications exchanged within the virtual space. Such communications may include one or more of textual chat, instant messages, private messages, voice communications, and/or other communications. Communications may be received and entered by the users via their respective client computing platforms. Communications may be routed to and from the appropriate users through virtual space module 28.

It should be appreciated that although modules 22, 23, 24, 25, 26, 27, and 28 are illustrated in FIG. 1 as being co-located within a single processing unit, in implementations in which processor(s) 20 includes multiple processing units, one or more of modules 22, 23, 24, 25, 26, 27, and/or 28 may be located remotely from the other modules. The description of the functionality provided by the different modules 22, 23, 24, 25, 26, 27, and/or 28 described herein is for illustrative purposes, and is not intended to be limiting, as any of modules 22, 23, 24, 25, 26, 27, and/or 28 may provide more or less functionality than is described. For example, one or more of modules 22, 23, 24, 25, 26, 27, and/or 28 may be eliminated, and some or all of its functionality may be provided by other ones of modules 22, 23, 24, 25, 26, 27, and/or 28. As another example, processor(s) 20 may be configured to execute one or more additional modules that may perform some or all of the functionality attributed to one of modules 22, 23, 24, 25, 26, 27, and/or 28.

Though server 10 may be described in certain sections herein as including server(s) 12, this is not intended to be limiting. Server(s) 12, or any component thereof, may be separate and distinct from system 10. In some implementations, one or more functionalities attributed herein to server(s) 12 may be provided by one or more third-party, external providers, and/or one or more of client computing platforms 14. For example, server(s) 12 may be implemented by a cloud of computing platforms operating together. In some implementations, one or more functionalities attributed herein to a third-party, external provider, and/or one or more of client computing platforms 14 may be provided by (and/or incorporated in) a constituent component of server(s) 12. Conversely, one or more functionalities attributed herein to server(s) 12 and/or its constituent components may be provided by a third-party, external provider and/or one or more client computing platforms 14.

Client computing platform(s) 14 may include one or more processors configured to execute computer program modules. The computer program modules may be configured to enable an expert or user associated with a given client computing platform 14 to interact with system 10, and/or external resources 16, and/or provide other functionality attributed herein to client computing platforms 14. By way of non-limiting example, the given client computing platform 14 may include one or more of a desktop computer, a laptop computer, a handheld computer, a NetBook, a Smartphone, a tablet, a gaming console, a wireless computing device, and/or other computing platforms.

External resources 16 may include sources of information, hosts and/or providers of virtual spaces and/or environments outside of system 10, external entities participating with system 10, external vendors, and/or other resources. In some implementations, some or all of the functionality attributed herein to external resources 16 may be provided by resources included in system 10.

Electronic storage 18 may comprise electronic storage media that electronically stores information. The electronic storage media of electronic storage 18 may include one or both of system storage that may be provided integrally (i.e., substantially non-removable) with server(s) 12 and/or removable storage that may be removably connectable to server(s) 12 via, for example, a port (e.g., a USB port, a FireWire port, etc.) or a drive (e.g., a disk drive, etc.). Electronic storage 18 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 18 may include one or more virtual storage resources (e.g., cloud storage, a virtual private network, and/or other virtual storage resources). Electronic storage 18 may store software algorithms, information determined by processor(s) 20, information received from server(s) 12, information received from client computing platforms 14, and/or other information that enables server(s) 12 to function as described herein.

Processor(s) 20 may be configured to provide information processing capabilities in server(s) 12 through one or more of hardware, software, and/or firmware. As such, processor(s) 20 may include one or more of a digital processor, an analog processor, a digital circuit designed to process information, an analog circuit designed to process information, a state machine, and/or other mechanisms for electronically processing information. Although processor(s) 20 may be shown in FIG. 1 as a single entity, this is for illustrative purposes only. In some implementations, processor(s) 20 may include a plurality of processing units. These processing units may be physically located within the same device, or processor(s) 20 may represent processing functionality of a plurality of devices operating in coordination.

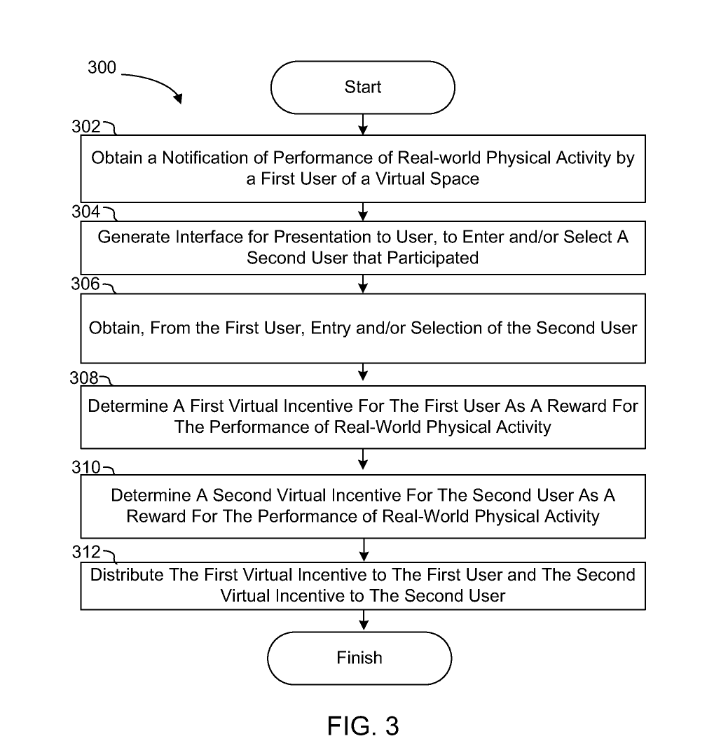

FIG. 3 illustrates an exemplary method 300 for distributing virtual incentives for real-world physical activity between multiple users. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At an operation 302, a notification is obtained of performance of real-world physical activities by (at least) a first user. In some implementations, operation 302 may be performed by an activity notification module the same as or similar to activity notification module 24 (shown in FIG. 1 and described above).

At an operation 304, an interface is generated for presentation to the first user, to enter and/or select one or more secondary users that participated in said performance. In some implementations, operation 304 may be performed by an interface module the same as or similar to interface module 25 (shown in FIG. 1 and described above).

At an operation 306, an entry and/or selection of the one or more secondary users is obtained. In some implementations, operation 306 may be performed by an interface module the same as or similar to interface module 25 (shown in FIG. 1 and described above).

At an operation 308, a first virtual incentive is determined for the first user as a reward for the performance of real-world physical activity. In some implementations, operation 308 may be performed by an incentive module the same as or similar to incentive module 26 (shown in FIG. 1 and described above).

At an operation 310, one or more secondary virtual incentives are determined for one or more secondary users as a reward for the (participation in the) performance of real-world physical activity. In some implementations, operation 310 may be performed by an incentive module the same as or similar to incentive module 26 (shown in FIG. 1 and described above).

At an operation 312, the first virtual incentive is distributed to the first user and one or more secondary virtual incentives are distributed to one or more secondary users. In some implementations, operation 312 may be performed by a distribution module the same as or similar to distribution module 27 (shown in FIG. 1 and described above).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for distributing, between multiple users, virtual incentives for real-world activities, the system comprising:
one or more processors configured to execute computer program modules, the computer program modules comprising:
an activity notification module configured to obtain a notification of performance of real-world physical activity by a first user of a virtual space;
an interface module configured to generate an interface for presentation to the first user, wherein the interface is configured to obtain, from the first user, entry and/or selection of a second user that participated in the real-world physical activity;
an incentive module configured such that, responsive to obtaining the notification by the activity notification module and obtaining the entry and/or selection of the second user by the interface module, the incentive module determines a first virtual incentive for the first user and a second virtual incentive for the second user, wherein the first virtual incentive and the second virtual incentive are rewards for the performance of real-world physical activity; and
a distribution module configured to distribute the first virtual incentive to the first user in the virtual space and to distribute the second virtual incentive to the second user.

2. The system of claim 1, wherein the notification is a level code that corresponds to a crossed threshold level amount of the real-world physical activity.

3. The system of claim 1, wherein the interface module is configured such that the interface is further configured to obtain, from the first user, entry and/or selection of a distribution parameter, and wherein the incentive module is configured such that determination of the second virtual incentive for the second user is based on the obtained distribution parameter.

4. The system of claim 3, wherein the incentive module is configured such that the first virtual incentive for the first user is based on the obtained distribution parameter.

5. The system of claim 3, wherein the interface module is configured such that the distribution parameter includes a percentage of the performed real-world physical activity.

6. The system of claim 3, wherein the interface module is configured such that the distribution parameter includes a time period of the real-world physical activity corresponding to participation of the second user.

7. The system of claim 3, wherein the interface module is configured such that the distribution parameter includes a selection of one or more options for the second virtual incentive.

8. A method for distributing, between multiple users, virtual incentives for real-world activities, the method comprising:
obtaining a notification of performance of real-world physical activity by a first user of a virtual space;
generating an interface for presentation to the first user, wherein the interface is configured to obtain, from the first user, entry and/or selection of a second user that participated in the real-world physical activity;
obtaining the entry and/or selection of the second user;
determining a first virtual incentive for the first user, wherein the first virtual incentive is a reward for the performance of real-world physical activity;
determining a second virtual incentive for the second user, wherein the second virtual incentive is a reward for the performance of real-world physical activity; and
distributing the first virtual incentive to the first user and the second virtual incentive to the second user.

9. The method of claim 8, wherein the notification is a level code that corresponds to a crossed threshold level amount of the real-world physical activity.

10. The method of claim 8, wherein the interface is further configured to obtain, from the first user, entry and/or selection of a distribution parameter, and wherein determining the second virtual incentive for the second user is based on the obtained distribution parameter.

11. The method of claim 10, wherein determining the first virtual incentive for the first user is based on the obtained distribution parameter.

12. The method of claim 10, wherein the distribution parameter includes a percentage of the performed real-world physical activity.

13. The method of claim 10, wherein the distribution parameter includes a time period of the real-world physical activity corresponding to participation of the second user.

14. The method of claim 10, wherein the distribution parameter includes a selection of one or more options for the second virtual incentive.
